(19) United States
(12) Patent Application Publication
(10) Pub. No.: US 2009/0291386 A1
(43) Pub. Date: Nov. 26, 2009

(54) IMAGE FORMING APPARATUS AND METHOD OF FORMING COLOR IMAGE USING THE SAME

(75) Inventor: Ji-won JEONG, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/401,828

(22) Filed: Mar. 11, 2009

(30) Foreign Application Priority Data
May 23, 2008 (KR) 10-2008-0048066

(51) Int. Cl. G03G 13/20; G03G 15/02; G03G 15/08

(52) U.S. Cl. 430/124.1; 399/50; 399/223

(57) ABSTRACT

Provided are an image forming apparatus and a method of forming a color image using the same. The image forming apparatus includes: an image forming medium forming a latent image and having a plurality of cells, wherein each cell operates independently and the cells are charged according to a color image to be recorded; a developing unit developing the latent image into the color image and comprising a plurality of toner cartridges containing different color toners, wherein the toner cartridges are aligned around the image forming medium and spaced apart from each other at predetermined intervals; a transferring unit transferring the color image to a recording medium; and a fixing unit fixing the color image that has been transferred to the recording medium, wherein, as the cells face the toner cartridges, the amount of charge applied to the cells is gradually increased and different color toners overlap on the cells, so that the latent image is developed into the color image.

### CROSS-REFERENCE TO RELATED PATENT APPLICATIONS

This application claims the benefit of Korean Patent Application No. 10-2008-0048066, filed on May 23, 2008, in the Korean Intellectual Property Office, the disclosure of which is incorporated herein in its entirety by reference.

### BACKGROUND OF THE INVENTION

1. Field of the Invention

Methods and apparatuses consistent with the present invention relate to formation of color images, and more particularly, to forming images by forming a latent image on an image forming medium, developing the latent image, transferring the developed image to a recording medium, and fixing the transferred image on the recording medium.

2. Description of the Related Art

Generally, an electrophotographic image forming apparatus forms images using the following method. An image forming medium whose entire surface is charged with a predetermined polarity is exposed to light corresponding to image data to be recorded so that a latent image is formed on the surface of the image forming medium. Then, the latent image is developed with a developer, such as toner, to form a developed image. The developed image is transferred to a recording medium and the transferred image is fixed on the recording medium, thereby completing the formation of an image on the recording medium.

As described above, to form images, conventional electrophotographic image forming apparatuses necessarily require an apparatus and process for charging the entire surface of an image forming medium with a predetermined polarity, and a process for exposing the surface of the image forming medium to light. Due to these requirements, there is a limit to how much the time required for data printing can be reduced.

Conventional electrophotographic color image forming systems can be classified as multi-pass type color image forming systems and single-pass type color image forming systems.

In multi-pass type color image forming systems, cyan toner, magenta toner, yellow toner, and black toner are sequentially applied to an image forming medium to develop a latent image. That is, a single image forming medium is treated with four toners.

In single-pass type color image forming systems, cyan toner, magenta toner, yellow toner, and black toner are respectively applied to image forming media to develop a latent image. That is, four drums, which are aligned with each other, are used to form color images.

In addition, there is another type of image forming system in which a charging process, an exposing process, and a developing process can be replaced with only one process using a direct imaging drum that can be self-charged.

However, in a multi-pass type color image forming system, a developing rate is low due to the sequential treatment with four colors. In addition, in a single-pass type color image forming system, four sets of image forming media and developing devices are required for the four colors and thus, additional components are required and the structure of the system is complex, and the manufacturing costs are high.

Furthermore, when image forming systems using a direct imaging drum are used and the toner is applied to the surface of a drum, multiple layers of toner cannot be applied and one dot unit can be used to express only one color. Therefore, color printing quality is lowered. Although this problem can be overcome by further using red, blue, and green, in addition to cyan, magenta, yellow, and black, use of the additional colors leads to an increase in the manufacturing and maintenance costs.

### SUMMARY OF THE INVENTION

Aspects of the present invention provide an image forming apparatus for forming a color image using an image forming medium including a plurality of cells, in which the cells are disposed in a matrix and each cell operates independently without a photoreceptor, and different color toners are sequentially attached in a multi-layer structure to the cells while the amount of the charge applied to the cells is gradually increased.

Aspects of the present invention also provide a method of forming a color image using the image forming apparatus.

According to an aspect of the present invention, there is provided an image forming apparatus including: an image forming medium which forms a latent image and has a surface which comprises a plurality of cells, wherein each cell operates independently and the cells are charged according to a color image to be recorded; a developing unit which develops the latent image into the color image and which comprises a plurality of toner cartridges containing different color toners, wherein the toner cartridges are aligned around the image forming medium and spaced apart from each other at predetermined intervals; a transferring unit which transfers the color image to a recording medium; and a fixing unit which fixes the color image that has been transferred to the recording medium, wherein as the cells face the toner cartridges, the amount of charge applied to the cells is gradually increased and different color toners overlap on each of the cells, so that the latent image is developed into the color image.

According to another aspect of the present invention, there is provided a method of forming a color image by depositing different color toners using the image forming apparatus of claim 1, the method including: (a) forming a latent image by charging a plurality of cells, on which different color toners are to overlap, to have an opposite polarity to an original polarity of the cells; (b) developing the latent image into a color image by gradually increasing the amount of charge applied to the cells according to the order in which a plurality of toner cartridges containing different color toners are aligned and overlapping different color toners; (c) transferring the developed color image to a recording medium; and (d) fixing the transferred color image on the recording medium.

### BRIEF DESCRIPTION OF THE DRAWINGS

The above and other features and advantages of the present invention will become more apparent by describing in detail exemplary embodiments thereof with reference to the attached drawings in which:

FIG. 1 is a perspective view of an image forming apparatus according to an exemplary embodiment of the present invention;

FIG. 2 is a sectional view of the image forming apparatus of FIG. 1, according to an exemplary embodiment of the present invention;

FIGS. 3A-3D are views illustrating an operation of developing a latent image into a color image in such a way that different color toners overlap as the amount of charge applied to a cell is gradually increased, according to an exemplary embodiment of the present invention;

FIG. 4 is a perspective view of one of a plurality of cells constituting a peripheral portion of an image forming medium of the image forming apparatus illustrated in FIGS. 1 and 2, according to an exemplary embodiment of the present invention;

FIG. 5 is a view illustrating the structure of the cell of FIG. 4, according to an exemplary embodiment of the present invention;

FIGS. 6 and 7 are views for explaining a method of changing polarity of the cell illustrated in FIG. 3A, according to an exemplary embodiment of the present invention; and

FIG. 8 is a flowchart illustrating a method of forming a color image by using an image forming apparatus according to the present invention, according to an exemplary embodiment of the present invention.

### DETAILED DESCRIPTION OF EXEMPLARY EMBODIMENTS OF THE INVENTION

The present invention will now be described more fully with reference to the accompanying drawings, in which exemplary embodiments of the invention are shown.

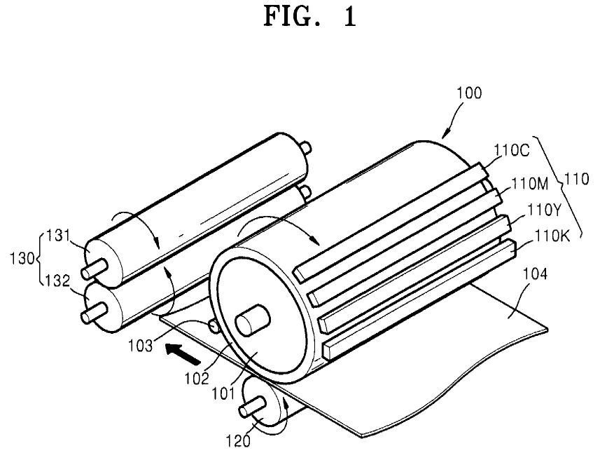

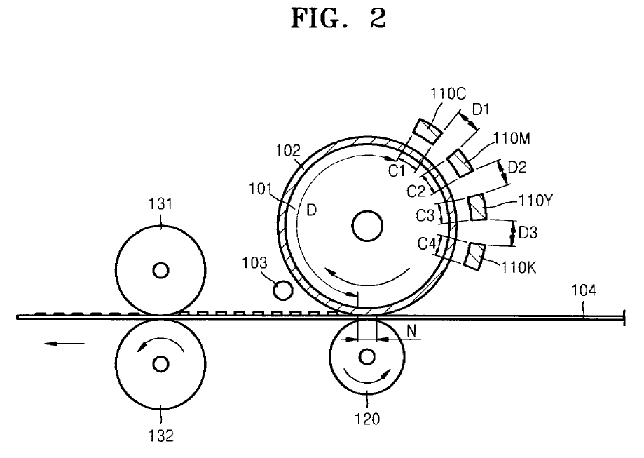

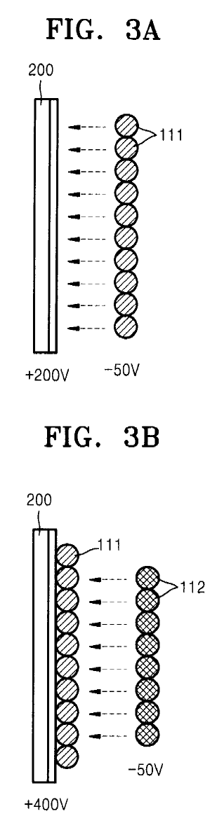

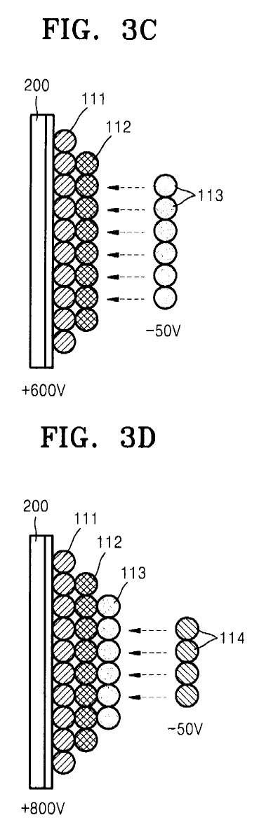

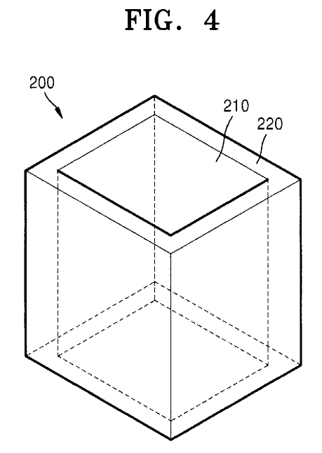

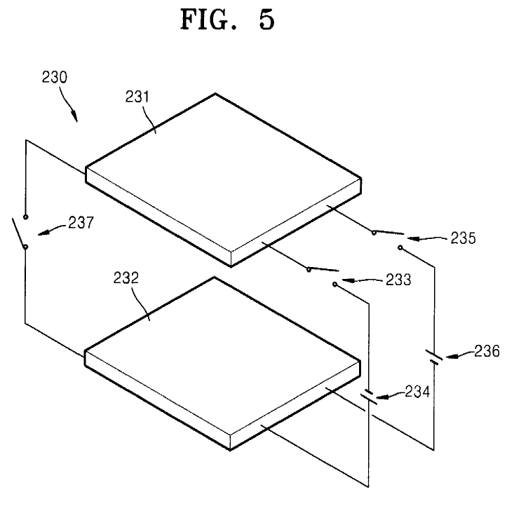

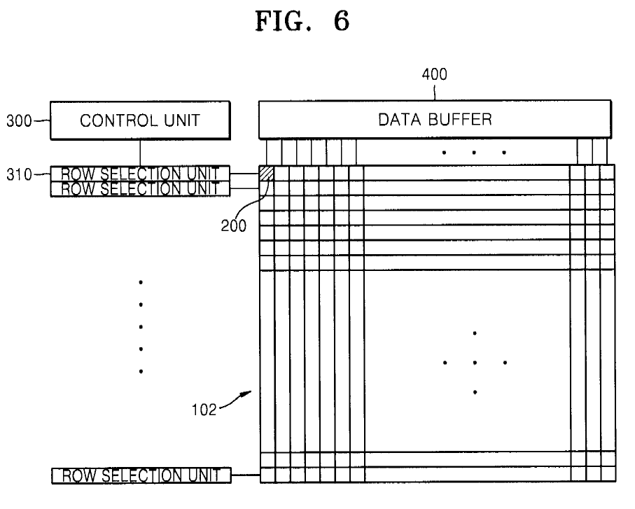

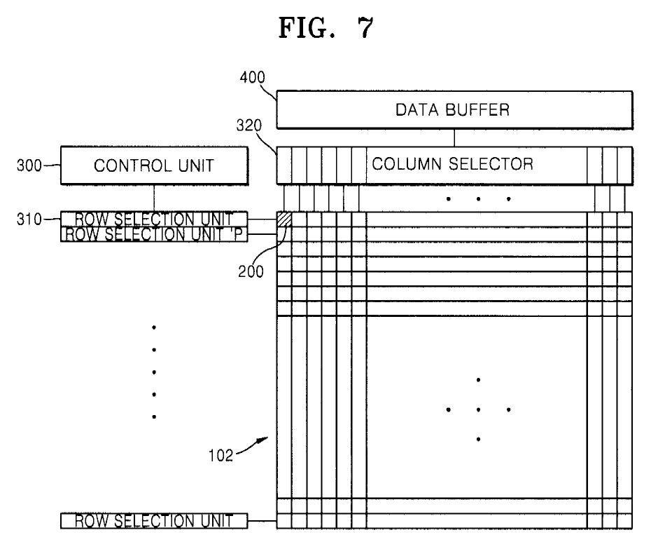

FIG. 1 is a perspective view of an image forming apparatus according to an embodiment of the present invention. FIG. 2 is a sectional view of the image forming apparatus of FIG. 1. FIGS. 3A-3D are views illustrating an operation of developing a latent image into a color image in such a way that different color toners overlap as the amount of charge applied to a cell is gradually increased, according to an embodiment of the present invention. FIG. 4 is a perspective view of one of a plurality of cells constituting a peripheral portion of the image forming medium illustrated in FIGS. 1 and 2. FIG. 5 is a view illustrating the structure of the cell of FIG. 4. FIGS. 6 and 7 are views for explaining a method of changing polarity of the cell illustrated in FIG. 3A, according to an embodiment of the present invention.

Referring to FIGS. 1-3D, the image forming apparatus according to the current embodiment includes an image forming medium 100 including a plurality of cells 200 for forming a latent image, formed on a circumference of the image forming medium 100, a cleaning unit 103 neutralizing a surface potential of the image forming medium 100, a developing unit 110 developing the latent image into a color image, a transferring unit 120 transferring the developed color image to a recording medium 104, a fixing unit 130 fixing the transferred color image on the recording medium 104, and a control unit 300 (see FIG. 6) controlling polarity of the cells 200 according to a color image to be recorded.

The image forming medium 100 may be a cylindrical photoreceptor. The image forming medium 100 includes a rotary body 101, and a peripheral portion 102 disposed on a circumferential surface of the rotary body 101, wherein the peripheral portion 102 includes the cells 200 that are arranged in a matrix as illustrated in FIGS. 3A-3D. The peripheral portion 102 can be formed in such a way that the cells 200 are formed using a flexible material and then the cells 200 are wound around the rotary body 101. The image forming medium 100 can also be a belt-type drum.

Referring to FIG. 4, each cell 200 includes a space portion 210 having a predetermined depth and a partition wall 220 having a predetermined thickness surrounding the space portion 210. The partition wall 220 is formed of a non-conductive material. In the cell 200, an x-axis length and a y-axis length may be dependent upon an output resolution (horizontal units x vertical units). For example, if the output resolution is 1200 dpi, each of the x-axis length and the y-axis length may be 0.02 mm (1/1200×25.4). In addition, the x-axis length and the y-axis length are also dependent upon the size of the partition wall 220, wherein the partition wall 220 separates adjacent cells 200 from each other so that a cell 200 charged by a condenser does not affect a charge state of its neighboring cell 200.

A device that can change polarity of the cell 200 is disposed in the space portion 210 of the cell 200. The device may be a condenser 230 illustrated in FIG. 5. The condenser 230 includes a first plate 231, a second plate 232, and a dielectric (not shown) interposed between the first plate 231 and the second plate 232. The first plate 231 partially constitutes a surface of the image forming medium 100. The first plate 231 and the second plate 232 are connected to a first charge switch device 233 and a second charge switch device 235. The first charge switch device 233 may connect the first plate 231 and the second plate 232 to a power source 234 so that the first plate 231 is positively charged and the second plate 232 is negatively charged, or disconnect the first plate 231 and the second plate 232 from the power source 234. The second charge switch device 235 may connect the first plate 231 and the second plate 232 to a power source 236 so that the first plate 231 is negatively charged and the second plate 232 is positively charged, or disconnect the first plate 231 and the second plate 232 from the power source. Accordingly, the first plate 231 and the second plate 232 can be positively or negatively charged by selectively operating the first charge switch device 233 and the second charge switch device 235. Meanwhile, toner that is to be attached due to an electrostatic phenomenon may have an opposite polarity to the polarity of the first plate 231. In the current embodiment, the first plate 231 is positively charged and toner is negatively charged. In addition, the first plate 231 can be coated with a specific material, that is, a material inducing static electricity to prevent abrasion or increase static electricity.

The first plate 231 and the second plate 232 are also connected to an initializing switching device 237. The initializing switching device 237 connects the first plate 231 to the second plate 232 and neutralizes each of the first and second plates 231 and 232.

Accordingly, when the first and second charge switching devices 233 and 235 are turned on, the initializing switching device 237 is turned off. On the other hand, when the initializing switching device 237 is turned on, the first and second charge switching devices 233 and 235 are turned off.

The first and second charge switching devices 233 and 235 and the initializing switching device 237 can be various types of devices that can cause electrostatic phenomena and can be controlled according to a signal applied thereto.

As described above, an image forming medium used according to an embodiment of the present invention has a different structure from that of conventional photoreceptors and can change its polarity by itself. In this aspect, the image forming medium used according to this aspect of the present invention can be referred to as a self image forming medium.

The developing unit 110 includes a plurality of toner cartridges which are spaced apart at predetermined intervals and are sequentially aligned round the image forming medium 100. The toner cartridges include a cyan toner cartridge 110C containing cyan toner, a magenta toner cartridge 110M containing magenta toner, a yellow toner cartridge 110Y containing yellow toner, and a black toner cartridge 110K containing black toner. Toners contained in the cyan, magenta, yellow and black toner cartridges 110C, 110M, 110Y, and 110K may have a negative charge (−).

In FIG. 2, C1, C2, C3 and C4 respectively denote areas of the image forming medium 100 facing the cyan, magenta, yellow and black toner cartridges 110C, 110M, 110Y, and 110K. The cyan toner cartridge 110C is spaced apart from the magenta toner cartridge 110M by a distance D1, the magenta toner cartridge 110M is spaced apart from the yellow toner cartridge 110Y by a distance D2, and the yellow toner cartridge 110Y is spaced apart from the black toner cartridge 110 B by a distance D3. In FIG. 2, D denotes a circumference of the image forming medium 100 starting from a nip N to the cyan toner cartridge 110C. The nip N is formed when the image forming medium 100 contacts the transferring unit 120. The alignment order of the cyan, magenta, yellow and black toner cartridges 110C, 110M, 110Y, and 110K, the areas C1, C2, C3 and C4, and the distances D1, D2, and D3 may differ according to characteristics of the image forming apparatus.

The transferring unit 120 transfers a color image formed by the developing unit 110 to the recording medium 104. Specifically, when the transferring unit 120 passes the nip N formed between the transferring unit 120 and the image forming medium 100, a portion of the image forming medium 100 that contacts the nip N is charged with such polarity that the toner of the color image is detached. Thus, a repulsion force is generated between the image forming medium 100 and the toner forming the color image, and the transferring unit 120 is charged with a polarity so as to attract the toner of the color image so that an attraction force is generated between the transferring unit 120 and the toner of the color image. For example, the portion of the image forming medium 100 that contacts the nip N may be charged with a negative charge (−) and the transferring unit 120 may be charged with a positive charge (+). The transferring unit 120 may be a transfer roller.

The fixing unit 130 fixes the color image that has been transferred to the recording medium 104 by the transferring unit 120. The fixing unit 130 includes a heating roller 131 generating heat, and a pressing roller 132 facing the heating roller 131 and applying pressure. Accordingly, the color image passing between the heating roller 131 and the pressing roller 132 is heated and pressed and thus fixed on the recording medium 104.

When the transferring process in which the color image is transferred by the transferring unit 120 is complete, the cleaning unit 103 removes residual toner on the surface of the image forming medium 100. In fact, however, the transferring unit 120 cannot completely transfer the color image and some toner remains on the surface of the image forming medium 100. The residual toner leads to a decrease in image quality in the subsequent recording process. Therefore, the residual toner should be removed to improve image quality. To this end, whenever the transferring process is completed, an electrical state of the surface of the image forming medium 100 should be neutralized to remove the residual toner on the surface of the image forming medium 100. For example, a portion of the image forming medium 100 on which toner exists can be neutralized so that negatively charged toner can be easily removed from the image forming medium 100.

The control unit 300 changes polarities of the cells 200 using a line control mode as illustrated in FIG. 6 or a cell control mode as illustrated in FIG. 7, thereby forming a latent image.

In the line control mode as illustrated in FIG. 6, a row selection unit 310 is installed at every row line, a line address is decoded and the decoded line address is transmitted to all the row selection units 310, and the control unit 300 selects the corresponding row line and charges cells 200 corresponding to image information about the corresponding row line in a data buffer 400.

In the cell control mode as illustrated in FIG. 7, a row selection unit 310 is installed at every row line, a column selection unit 320 is installed at every column line, a line address is decoded and the decoded line address is transmitted to all the row selection units 310 and all the column selection units 320, and each row selection unit 310 and each column selection unit 320 select the corresponding cell and charge the selected cell according to the corresponding cell information in the data buffer 400.

Hereinafter, a method of forming a color image by overlapping different color toners on a cell using the image forming apparatus according to the present invention will be described in detail.

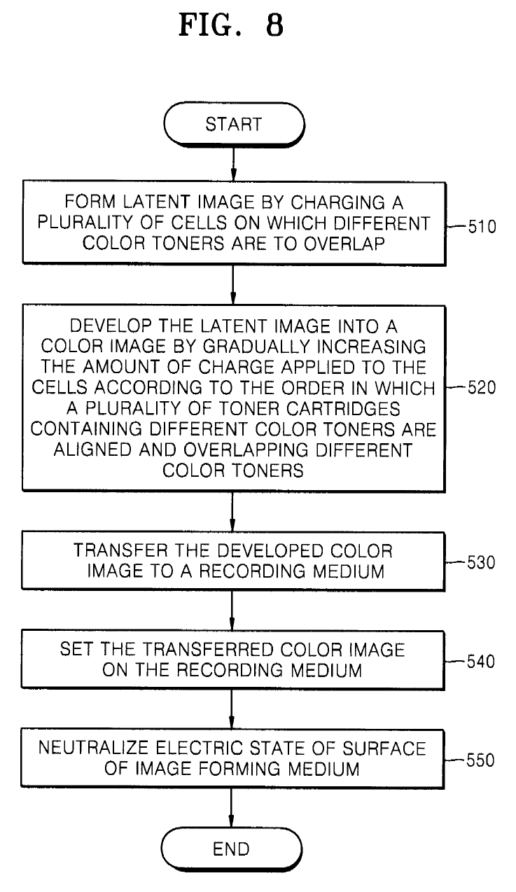

FIG. 8 is a flowchart illustrating a method of forming a color image using the image forming apparatus of FIG. 1, according to an embodiment of the present invention.

Referring to FIGS. 2, 3A-3D, and 8, the cells 200, on which different color toners are to overlap, are charged with an opposite polarity to an original polarity of the cells 200 so as to form a latent image (Operation 510 of FIG. 8).

After Operation 510, the amount of charge applied to the cells 200 is gradually increased as the cyan, magenta, yellow and black toner cartridges 110C, 110M, 110Y, and 110K which contain different color toners are sequentially passed by the cells 200 and different color toners overlap on the cells, thereby developing the latent image into a color image (Operation 520 of FIG. 8).

Operation 520 will now be described in detail.

Referring to FIG. 3A, to attract cyan toner 111 charged with −50V, the cell 200 is charged with +200 V immediately before the cell 200 arrives at the area C1 (see FIG. 2). When the cell 200 is in the area C1, the cyan toner 111 contained in the cyan toner cartridge 110C is attached to the cell 200 due to static electricity.

Referring to FIG. 3B, to attract magenta toner 112 charged with V, the cell 200 is charged with +400 V immediately before the cell 200 arrives at the area C2 (see FIG. 2), that is, the cell 200 is charged with +400 V when the cell 200 is within the distance D1 (see FIG. 2) before arriving at the area C2. Since the cyan toner 111 is already attached to the cell 200, the cyan toner 111 hinders the attachment of the magenta toner 112. Therefore, the amount of charge applied to the cell 200 is increased to +400 V so that the magenta toner 112 is attached to the cyan toner 111. When the cell 200 is in the area C2, the magenta toner 112 contained in the magenta toner cartridge 110M is attached to the cyan toner 111 due to static electricity.

Referring to FIG. 3C, to attract yellow toner 113 charged with −50V, the cell 200 is charged with +600 V immediately before the cell 200 arrives at the area C3 (see FIG. 2), that is, the cell 200 is charged with +600 V when the cell 200 is within the distance D2 (see FIG. 2) before arriving at the area C3. Since the cyan toner 111 and the magenta toner 112 are already attached to the cell 200, the cyan toner 111 and the magenta toner 112 hinder the attachment of the yellow toner 113. Therefore, the amount of charge applied to the cell 200 is increased to +600 V so that the yellow toner 113 is attached to the cyan toner 111 and the magenta toner 112. When the cell 200 is in the area C3, the yellow toner 113 contained in the yellow toner cartridge 110Y is attached to the cyan toner 111 and the magenta toner 112 due to static electricity.

Referring to FIG. 3D, to attract black toner 114 charged with −50V, the cell 200 is charged with +800 V immediately before the cell 200 arrives at the area C4 (see FIG. 2), that is, the cell 200 is charged with +800 V when the cell 200 is within the distance D3 (see FIG. 2) before arriving at the area C4. Since the cyan toner 111, the magenta toner 112, and the yellow toner 113 are already attached to the cell 200, the cyan toner 111, the magenta toner 112, and the yellow toner 113 hinder the attachment of the black toner 114. Therefore, the amount of charge applied to the cell 200 is increased to +800 V so that the black toner 114 is attached to the cyan toner 111, the magenta toner 112, and the yellow toner 113. When the cell 200 is in the area C4, the black toner 114 contained in the black toner cartridge 110K is attached to the cyan toner 111, the magenta toner 112, and the yellow toner 113 due to static electricity.

As described above, when the cyan, magenta, yellow and black toner cartridges 110C, 110M, 110Y, and 110K are sequentially passed by the image forming medium 100, the cyan toner 111, the magenta toner 112, the yellow toner 113, and the black toner 114 overlap on the cell 200. The type of toners that are to be attached to the cell 200 may differ according to image data to be recorded. Even when toners are different from those used in the current embodiment, the amount of charge applied to the cell 200 can be gradually increased according to the toners that overlap on the cell.

The amount of charge applied to the cell 200 can be increased based on the principle of a condenser. In general, the amount of charge applied to a condenser is roughly proportional to the charging time. Thus, the amount of charge applied to a condenser can be adjusted by controlling the charging time. For example, let's assume that a condenser can be charged with up to 800 V for 8 seconds. In this case, to attach the cyan toner 111 to the cell 200 as illustrated in FIG. 3A, the first charge switching device 233 (see FIG. 5) is turned on for 2 seconds and then turned off, so that the cell 200 is charged with +200 V.

Then, to further attach the magenta toner 112 to the cell 200 as illustrated in FIG. 3B, the first charge switching device 233 (see FIG. 5) is further turned on for two seconds and then turned off, so that the cell 200 is charged with +400 V.

Then, to further attach the yellow toner 113 to the cell 200 as illustrated in FIG. 3C, the first charge switching device 233 (see FIG. 5) is further turned on for two seconds and then turned off, so that the cell 200 is charged with +600 V.

Then, to further attach the black toner 112 to the cell 200 as illustrated in FIG. 3D, the first charge switching device 233 (see FIG. 5) is further turned on for two seconds and then turned off, so that the cell 200 is charged with +800 V.

The maximum amount of charge applied to the cell 200 can be controlled according to a distance between the image forming medium 100 and the cyan, magenta, yellow and black toner cartridges 110C, 110M, 110Y, and 110K. For example, when the distance between the image forming medium 100 and the cyan, magenta, yellow and black toner cartridges 110C, 110M, 110Y, and 110K is relatively small, the maximum amount of charge applied to the cell 200 can be adjusted to be relatively small.

After Operation 520, when the color image formed on the surface of the image forming medium 100 passes through the nip N between the transferring unit 120 and the image forming medium 100, the color image is transferred to the recording medium 104 due to static electricity (Operation 530 of FIG. 8).

After Operation 530, when the color image transferred to the recording medium 104 passes through the fixing unit 130, the color image is fixed on the recording medium 104 (Operation 540 of FIG. 8).

After Operation 540, when the image forming medium 100 passes by the cleaning unit 103, the cleaning unit 103 neutralizes an electrical state of the cells 200 (Operation 550 of FIG. 8).

As described above, an image forming apparatus and a method of forming color images using the same according to the exemplary embodiments of the present invention have the following effects.

First, as a plurality of toner cartridges are sequentially passed by a plurality of cells, the amount of charge applied to the cells, each operating independently, is gradually increased and a plurality of toners overlap on the cells, thereby developing a latent image into a color image. Therefore, image quality can be improved.

Second, a desired color image can be formed by sequentially exposing toner cartridges to an image forming medium. Therefore, a color image forming rate can be increased.

Third, the image forming apparatus can be manufactured in small sizes and the number of necessary components can be decreased. Therefore, the manufacturing costs can be lowered.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An image forming apparatus comprising:
an image forming medium which forms a latent image and has a surface comprising a plurality of cells, wherein each of the cells operates independently and the cells are charged according to a color image to be recorded;
a developing unit which develops the latent image into the color image and which comprises a plurality of toner cartridges containing different color toners, wherein the toner cartridges are aligned around the image forming medium and spaced apart from each other at predetermined intervals;
a transferring unit which transfers the color image to a recording medium; and
a fixing unit which fixes the color image that has been transferred to the recording medium, wherein
as the cells face the toner cartridges, an amount of charge applied to the cells is gradually increased and different color toners overlap on each of the cells, so that the latent image is developed into the color image.

2. The image forming apparatus of claim 1, wherein the amount of charge applied to the cells is increased immediately before the cells face each toner cartridge.

3. The image forming apparatus of claim 2, wherein the amount of charge applied to the cells is increased in an area between adjacent toner cartridges to attract toner of a toner cartridge the cells are about to face.

4. The image forming apparatus of claim 1, wherein, when the toner cartridges are sequentially passed by the cells, polarities of the cells are maintained constant.

5. The image forming apparatus of claim 1, wherein an overall amount of charge applied to the cells is gradually increased in such a way that whenever the cells face each toner cartridge, the amount of charge applied to the cells is increased.

6. The image forming apparatus of claim 1, further comprising a cleaning unit which neutralizes an electrical state of the cells when the operation of the transferring unit is complete.

7. The image forming apparatus of claim 1, further comprising a control unit which controls the amount of charge applied to the cells in order to deposit different color toners corresponding to data of the color image that is to be recorded.

8. A method of forming a color image by depositing different color toners using an image forming apparatus, the method comprising:
(a) forming a latent image by charging a plurality of cells, on which different color toners are to overlap, to have an opposite polarity to an original polarity of the cells;
(b) developing the latent image into a color image by gradually increasing the amount of charge applied to the cells according to the order in which a plurality of toner cartridges containing different color toners are aligned and overlapping different color toners;
(c) transferring the developed color image to a recording medium; and
(d) fixing the transferred color image on the recording medium.

9. The method of claim 8, wherein, in operation (b), the amount of charge applied to the cells is increased immediately before the cells face the toner cartridges.

10. The method of claim 9, wherein, in operation (b), the amount of charge applied to the cells is increased in an area between adjacent toner cartridges to attract toner of a toner cartridge the cells are about to face.

11. The method of claim 8, wherein, in operation (b), when the toner cartridges are sequentially passed by the cells, polarities of the cells are maintained constant.

12. The method of claim 8, wherein, in operation (b), the overall amount of charge applied to the cells is gradually increased in such a way that whenever the cells face each toner cartridge, the amount of charge applied to the cells is increased.

13. The method of claim 8, further comprising, after operation (d), neutralizing an electrical state of the cells.

14. An image forming apparatus comprising:
an image forming medium which forms a latent image and has a surface comprising a plurality of cells;
a developing unit which develops the latent image into the color image and which comprises a plurality of toner cartridges containing different color toners, wherein the toner cartridges are aligned around the image forming medium and spaced apart from each other;
a control unit which controls an amount of charge applied to the cells so that when the cells pass the toner cartridges the cells have different charges respectively corresponding to each of the toner cartridges.

15. The image forming apparatus according to claim 14, wherein as the cells face the toner cartridges, an amount of charge applied to the cells is increased and different color toners overlap on each of the cells, so that the latent image is developed into the color image.

16. The image forming apparatus according to claim 15, further comprising:
a transferring unit which transfers the color image to a recording medium; and
a fixing unit which fixes the color image that has been transferred to the recording medium.
